(19) United States
(12) Patent Application Publication
(10) Pub. No.: US 2023/0413710 A1
(43) Pub. Date: Dec. 28, 2023

(54) TILLAGE GANG ADJUSTMENT

(71) Applicant: Brandt Industries Canada Ltd., Regina (CA)

(72) Inventors: Blake Neudorf, Warman (CA); Alex Hansen, Saskatoon (CA); Dale Summach, Saskatoon (CA)

(21) Appl. No.: 17/847,269

(22) Filed: Jun. 23, 2022

(51) Int. Cl. A01B 63/24

(52) U.S. Cl. CPC A01B 63/24

(57) ABSTRACT

A cultivator is provided having a tool frame, a mounting bar provided below the tool frame, and a plurality of ground engaging tools connected to and extending below the mounting bar. The mounting bar can be connected to the tool frame by a plurality of mounting brackets and at least one adjustment mounting bracket. The mounting brackets allowing the mounting bar to be moved laterally relative to the tool frame and the at least one adjustment mounting bar allowing for the lateral adjustment of the mounting bar and ground engaging tools relative to the tool frame.

### FIELD OF THE INVENTION

The present invention relates to cultivators and more specifically mechanisms to adjust a lateral position of ground engaging tools of the cultivator.

### BACKGROUND

Cultivators are used in agriculture to till a field by mechanically agitating the soil. This can be done for a number of reasons including to prepare a good seed bed for crops to be planted in the field. To create a good seed bed, the cultivator must create a uniform under surface floor. A good seed bed allows a planter, following the cultivation of the field, to properly seed the field.

With a cultivator that uses angled discs to agitate the soil, a cutting profile the discs cut into the soil is a parabolic shape which starts at its greatest width at the surface of the soil and tapers to no cut at the deepest point of the cutting profile. At the surface, the width of the cutting profile is typically less than the spacing of the discs, leaving paths of soil untouched by the discs of the cultivator as they pass through the soil in the field. However, by going faster, soil thrown from a disc as it cuts through the soil can fracture soil in these paths of untilled soil; breaking up the soil in these paths which can have the effect of a completely tilled pass.

As the cultivator is pulled through a field, the soil conditions in the field can vary. For example, the moisture content, compaction of the soil in the field, amount of surface residue, etc., can all change the soil conditions in different parts of the field. This change of the soil conditions can change the distance soil is thrown by the discs and therefore the effectiveness of the discs ability to knock down the paths of untouched soil between the cutting profiles of the discs. Additionally, over time and with repeated use of the cultivator, the discs can wear down causing the diameter of the discs to decrease and therefore the discs will have a smaller active cutting width. This smaller active cutting width will increase the path of the untilled soil between the discs.

### SUMMARY OF THE INVENTION

In a first aspect, a cultivator is provided having a hitch assembly connectable to a tow vehicle to tow the cultivator in a travel direction, a tilling section having a front end and a back end, a tool frame provided in the tilling section, a mounting bar provided below the tool frame, a plurality of ground engaging tools connected to and extending below the mounting bar, a plurality of mounting brackets attaching the mounting bar to the tool frame, the mounting bracket allowing the mounting bar to be moved laterally relative to the tool frame, and at least one adjustment mounting bracket attaching the mounting bar to the tool frame and operative to adjust the mounting bar laterally relative to the tool frame.

In a further aspect, the cultivator has an adjustment mounting bracket which has a connection arm connected to the mounting bar, a frame connector connected to the tool frame, an adjustment member, and an adjustment rod provided between the adjustment member and the connection arm to adjust the connection arm relative to the frame connector.

### BRIEF DESCRIPTION OF THE DRAWINGS

A preferred embodiment of the present invention is described below with reference to the accompanying drawings, in which:

FIG. 1 is a top view of a cultivator;

FIG. 2 is a side view of the cultivator shown in FIG. 1;

FIG. 3 is a perspective view of the cultivator shown in FIG. 1;

FIG. 4 is a rear perspective view of the cultivator shown in FIG. 1;

FIG. 5 is a perspective view of the cultivator shown in FIG. 1 in a transport position;

FIG. 6 is a perspective view of a tool frame having a number of ground engaging tools;

FIG. 7 is a perspective view of a ground engaging tool;

FIG. 8 is a front view of the ground engaging tool shown in FIG. 7;

FIG. 9 is a side view of the ground engaging tool shown in FIG. 7 and mounted on a mounting bar;

FIG. 10 is a close up view of a mounting bracket;

FIG. 11 is a close up view of an adjustment mounting bracket;

FIG. 12 is a schematic rear view of ground engaging tools tilling a field;

FIG. 13 is a front schematic view of ground engaging tools tilling a field; and

FIG. 14 is a schematic view of cutting profiles cut into soil into a field.

### DETAILED DESCRIPTION OF THE ILLUSTRATED EMBODIMENTS

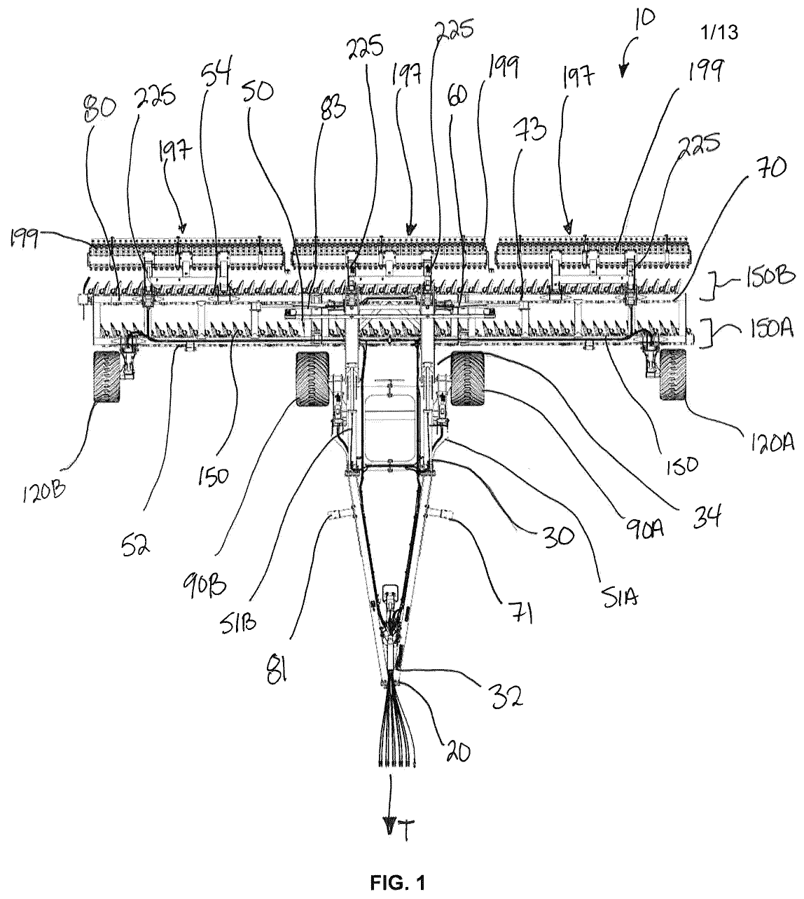

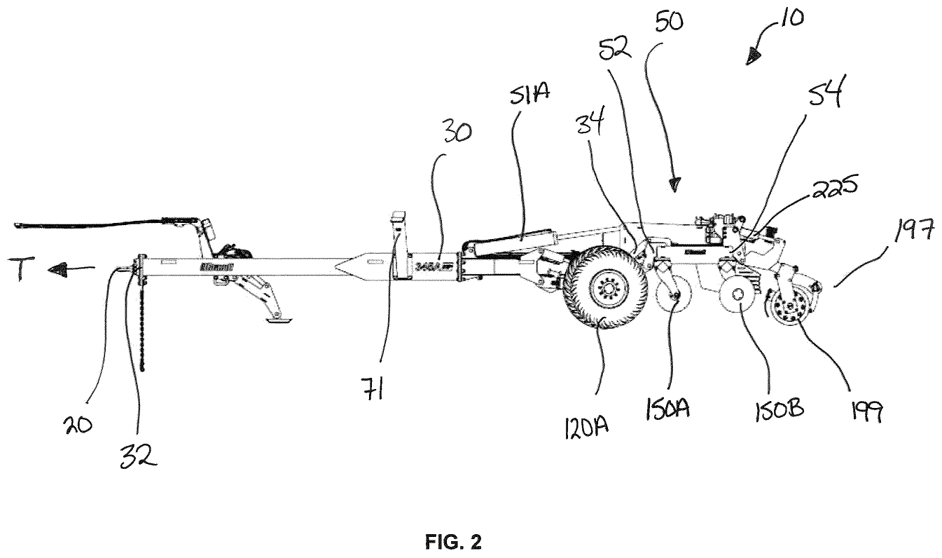

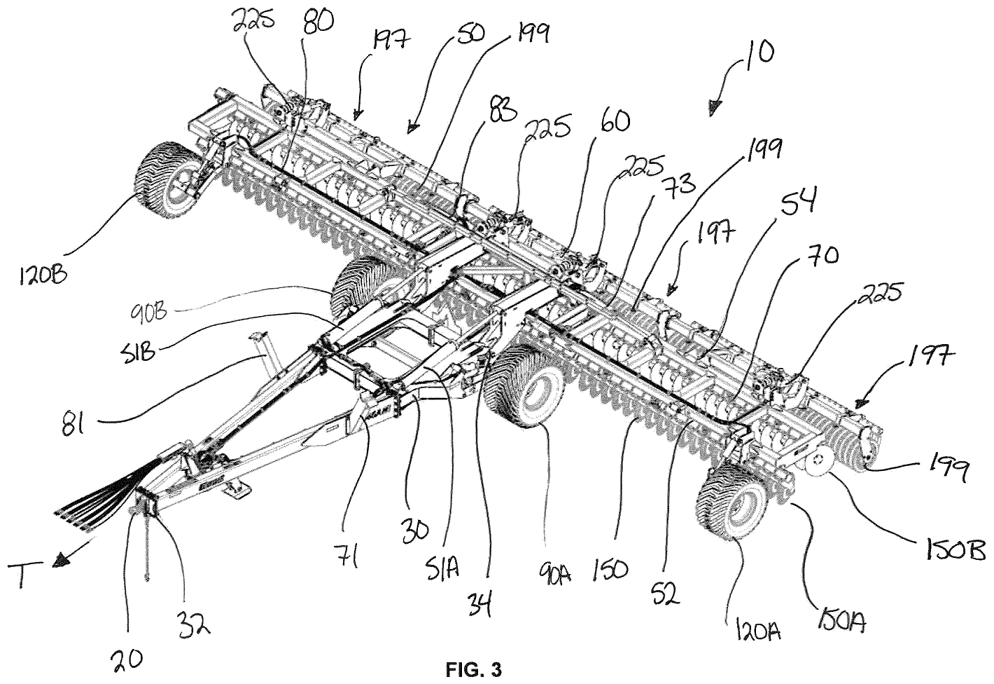

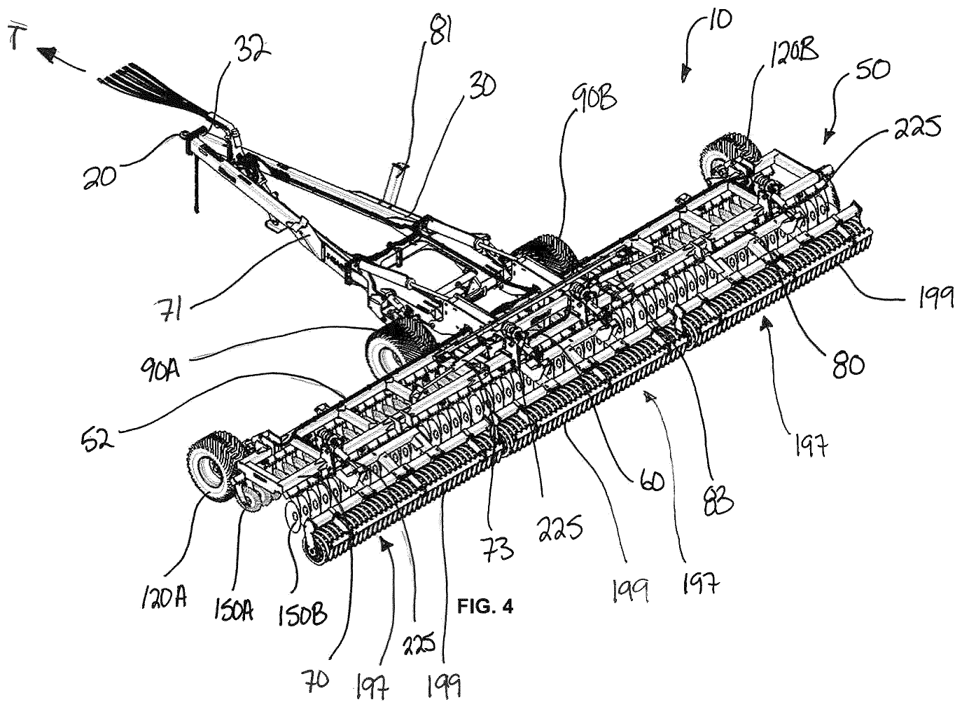

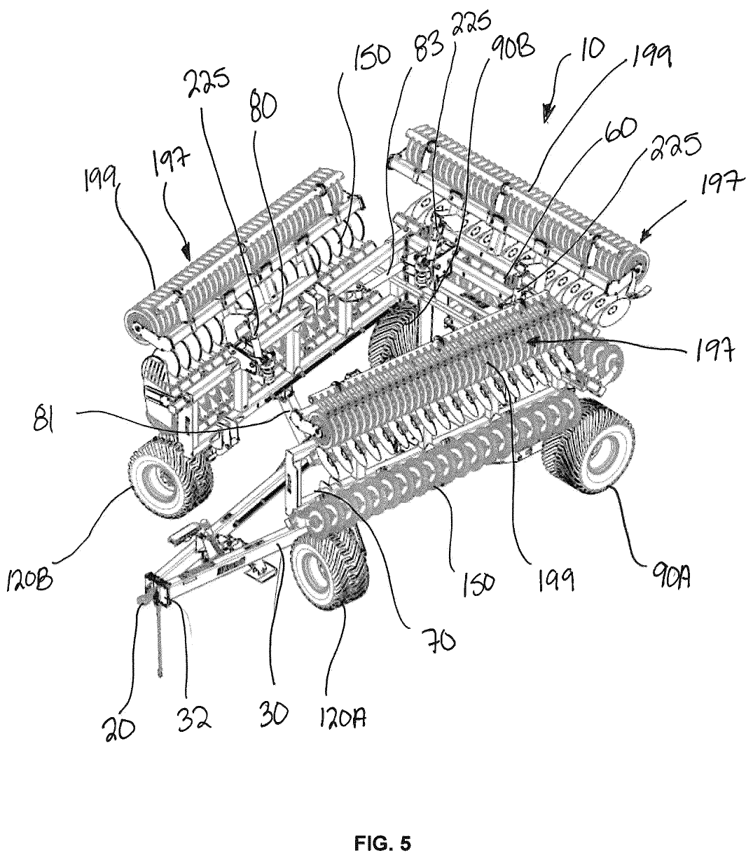

FIGS. 1-4 illustrate a cultivator 10 for cultivating or tilling a field, typically used for growing agricultural crops. The cultivator 10 is pulled behind a tow vehicle (not shown), while the cultivator 10 is in a field position (as shown in FIGS. 1-4). Ground engaging tools 150 extend down from the cultivator 10 to penetrate into the soil of the field and till the soil in the field by agitating the soil as the cultivator 10 is pulled through the field by the tow vehicle. The cultivator 10 can be transformed into a transport position, as shown in FIG. 5, so that it can be towed from field to field, such as along a public roadway. The cultivator 10 can comprise: a hitch assembly 20; a main frame 30; a tilling section 50 having a rear frame 60, a first wing frame 70, and a second wing frame 80; tilling section actuators 51A, 51B; a first wing actuator 73; a second wing actuator 83; a pair of main ground wheels 90A, 90B; a pair of wing ground wheels 120A, 120B; ground engaging tools 150; packing assemblies 197; and packer actuators 225.

The main frame 30 can have a front end 32 and a back end 34 with the hitch assembly 20 connected to the front end 32 of the main frame 30 for attachment to the tow vehicle (not shown) to tow the cultivator 10 in the travel direction, T. The main frame 30 can be pivotally attached to the tilling section 50, comprising the rear frame 60, the first wing frame 70, and the second wing frame 80, by the back end 34 of the main frame 30 being pivotally connected to the rear frame 60 so that the rear frame 60 can pivot upwards around the back end 34 of the main frame 30.

The pair of main ground wheels 90A, 90B can be movably attached to the main frame 30 so that the main ground wheels 90A, 90B can be moved vertically relative to the main frame 30 to raise and lower the main frame 30 relative to the main ground wheels 90A, 90B and thereby alter the height of the main frame 30 above the ground surface.

A pair of tilling section actuators 51A, 51B, such as double acting hydraulic cylinders, can be provided extending between the main frame 30 and the rear frame 60. Retracting these tilling section actuators 51A, 51B will cause the rear frame 60 to pivot upwards relative to the main frame 30 and around the back end 34 of the main frame 30. Extending these tilling section actuators 51A, 51B will pivot the rear frame 60 downwards relative to the main frame 30 and around the back end 34 of the main frame 30.

The rear frame 60, the first wing frame 70, and the second wing frame 80 together form the tilling section 50 having a front end 52 and a back end 54.

A front end of the rear frame 60 can be pivotally connected to the back end 34 of the main frame 30 so that the rear frame 60 can pivot relative to the back end 34 of the main frame 30. A first side of the rear frame 60 can be pivotally connected to the first wing frame 70 and a second side of the rear frame 60 can be pivotally connected to the second wing frame 80.

The first wing frame 70 can be pivotally connected to a first side of the rear frame 60 so that the first wing frame 70 can pivot relative to the rear frame 60 around the first side of the rear frame 60. The first wing ground wheel 120A can be attached at a front end of the first wing frame 70 and be movably attached so that the first wing ground wheel 120A can be moved vertically, relative to the front end of the first wing frame 70 to raise and lower the front end of the first wing frame 70 and adjust the height of the front end of the first wing frame 70 above the ground surface.

The second wing frame 80 can be pivotally connected to a second side of the rear frame 60 so that the second wing frame 80 can pivot relative to the rear frame 60 around the second side of the rear frame 60. The second wing ground wheel 120B can be attached at a front end of the second wing frame 80 and movably attached to the front end of the second wing frame 80 so that the second wing ground wheel 120B can be moved vertically, relative to the front end of the second wing frame 80, to raise and lower the front end of the second wing frame 80 and adjust the height of the front end of the second wing frame 80 above the ground surface.

The rear frame 60, the first wing frame 70 and the second wing frame 80 are tool frames for holding the ground engaging tools 150. The ground engaging tools 150 extend downwards beneath the tilling section 50 for penetrating the ground surface and agitating with the soil as the ground engaging tools 150 are pulled through the soil. The ground engaging tools 150 can be positioned in a first row of ground engaging tools 150A and a second row of ground engaging tools 150B in the tilling section 50. The first row of ground engaging tools 150A can be positioned in front of, and parallel to, the second row of ground engaging tools 150B.

Packer assemblies 197 can be attached to the back end 54 of the tilling section 50 and have a packer roller 199 to pack and flatten the soil after it has been tilled up by the ground engaging tools 150 in the tilling section 50 with one packer assembly 197 attached behind the rear frame 60, one packer assembly 197 attached behind the first wing frame 70 and one packer assembly 197 attached behind the second wing frame 80. Each packer assembly 197 can be pivotally connected to the back end 54 of the tilling section 50. The packer actuators 225 allow the packer assemblies 197 to be selectively pivoted around the back end 54 of the tilling section 50.

The cultivator 10 can be transformed from the field position, as shown in FIGS. 1-4, to the transport position, shown in FIG. 5 for transport from field to field. The tilling section actuators 51A, 51B can be retracted to pivot the tilling section 50 upwards and specifically the rear frame 60 around the back end 34 of the main frame 30. This will lift the rear frame 60 as well as the first wing frame 70 and the second wing frame 80 that are attached to the sides of the rear frame 60, up off the ground surface. The main ground wheels 90A, 90B are attached to the main frame 30 so the main ground wheels 90A, 90B will remain in place as the tilling section 50 is pivoted upwards around the back end 34 of the main frame 30. As the tilling section 50 is pivoted upwards to perpendicular relative to the main frame 30, the weight of the tilling section 50 will move forward onto the main ground wheels 90A, 90B attached to the main frame 30.

When the tilling section 50 is pivoted substantially perpendicular relative to the main frame 30, the first wing actuator 73 can be used to pivot the first wing frame 70 relative to the rear frame 60, forwards towards the front end 32 of the main frame 30 and the second wing actuator 83 can be used to pivot the second wing frame 80 relative to the rear frame 60, forwards towards the front end 32 of the main frame 30. The first wing frame 70 can be rested on, and connected to, a first wing brace 71 and the second side wing frame 80 can be rested on, and connected to, a second wing brace 81 to secure the first and second wing frames 70, 80 in the transport position shown in FIG. 5.

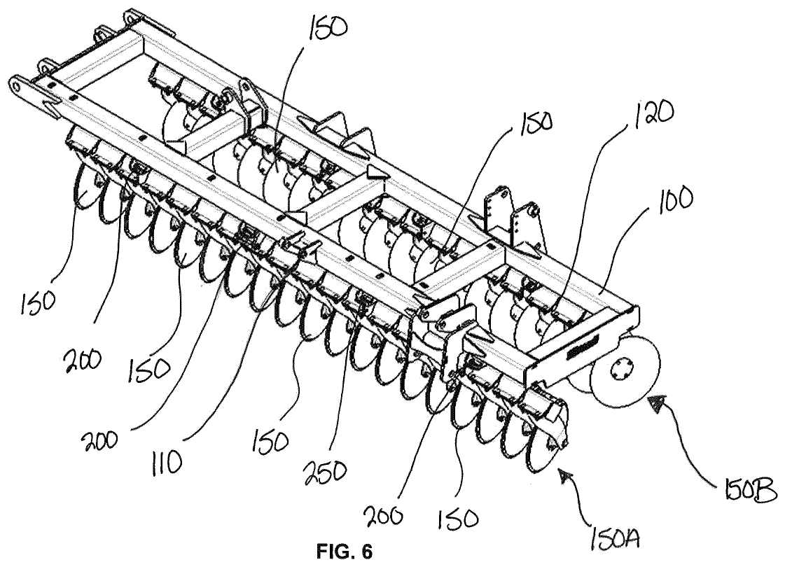

FIG. 6 shows a tool frame 100 that supports the ground engaging tools 150. The tool frame 100 could be rear frame 60, first wing frame 70 or second wing frame 80. The tool frame 100 can support a first mounting bar 110 and a second mounting bar 120. The first mounting bar 110 can be provided in front of the second mounting bar 120 so that when ground engaging tools 150 are connected to the first mounting bar 110 and the second mounting bar 120, the ground engaging tools 150 connected to the first mounting bar 110 form the first row of ground engaging tools 150A and the ground engaging tools 150 connected to the second mounting bar 120 form the second row of ground engaging tools 150B.

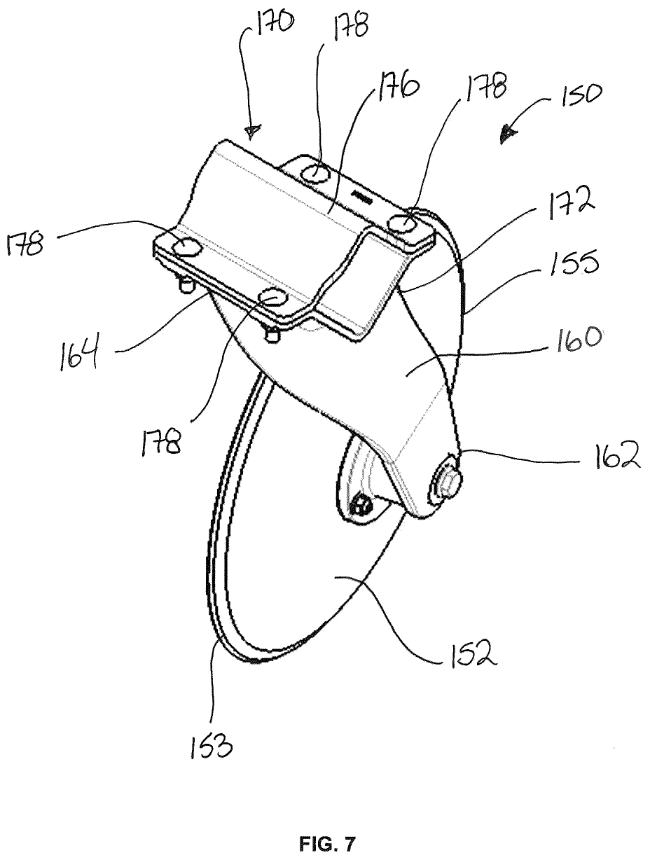

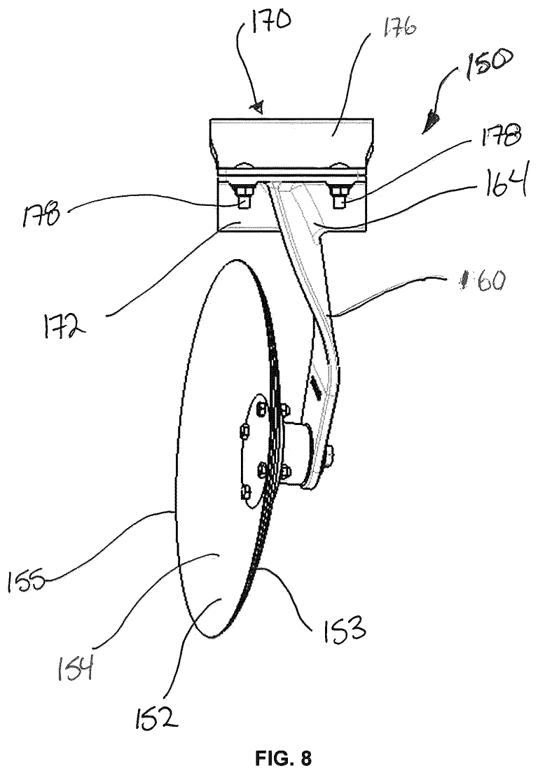

FIG. 7 shows a ground engaging tool 150. The ground engaging tool 150 can have a disc 152; a disc arm 160; and an attachment mechanism 170.

Although FIG. 7 shows the disc 152 as a smooth disc, the disc 152 could also be a wavy disc, etc. The disc 152 can be rotatably attached to the disc arm 160 at a bottom end 162 of the disc arm 160 so that the disc 152 can rotate relative to the disc arm 160. A top end 164 of the disc arm 160 can be attached to the attachment mechanism 170.

The disc 152 can be angled by the disc arm 160 so that the disc 152 is angled relative to a travel direction of the ground engaging tool 150 and cuts a parabolic shaped cutting profile in the soil as the ground engaging tool 150 is pulled through the soil in a field. The angling of the disc 152 causes the disc 152 to have a front cutting edge 153, a forward face 154, and a trailing edge 155.

The attachment mechanism 170 provided at the top end 164 of the disc arm 160 attaches the ground engaging tool 150 to one of the mounting bars 110, 120 shown in FIG. 6. The attachment mechanism 170 can have a bottom bracket 172 attached to the top end 164 of the disc arm 160 and a cap bracket 176 that is connectable to the bottom bracket 172. Bolt holes in the bottom bracket can align with bolt holes in the cap bracket 176 so that bolts 178 can be inserted through the aligned bolt holes to connect the cap bracket 176 to the bottom bracket 172. The bottom bracket 172 and cap bracket 176 can form a diamond shape when the cap bracket 176 is connected to the bottom bracket 172.

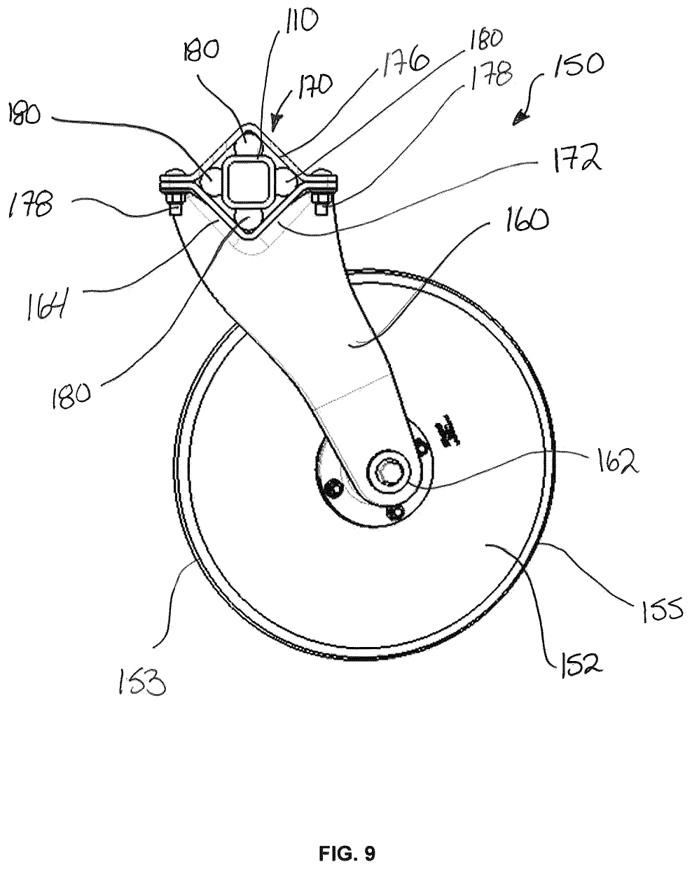

Cylindrical torsion elements 180, shown in FIG. 9, can be provided in the corners of the diamond shape formed by the cap bracket 176 and the bottom bracket 172. When the attachment mechanism 170 is attached to a mounting bar 110 (or mounting bar 120), the torsion elements 180 will be positioned in between the corners of the diamond shaped opening between the cap bracket 176 and the bottom bracket 172 and the outer surfaces of the square-shaped mounting bar 110 so that the torsion elements 180 isolate the attachment mechanism 170 from the mounting bar 110. This will allow the ground engaging tool 150 to move a small amount relative to the mounting bar 110, 120, such as when the disc 152 encounters a rock in its path or a denser patch of soil.

Referring again to FIG. 6, the attachment mechanism 170 of each ground engaging tool 150 can be bolted onto one of the mounting bars 110, 120 connected below the tool frame 100. Each mounting bar 110, 120 can have a square cross-section that is smaller than the square-shaped opening formed between the cap bracket 176 and the bottom bracket 172.

To mount a ground engaging tool 150 on the first mounting bar 110 or the second mounting bar 120, the cap bracket 176 of the ground engaging tool 150 can be disconnected from the bottom bracket 172. The bottom bracket 172, with the disc arm 160 extending from the bottom bracket 172, can be positioned below the mounting bar 110, 120. The cylindrical torsion elements 180 can be provided in the corners of the diamond shape formed by the cap bracket 176 and the bottom bracket 172. The cap bracket 176 can then be connected to the bottom bracket 172, with the bolts 178, so that the mounting bars 110, 120 passes through the opening formed by the cap bracket 176 and the bottom bracket 172 and the cylindrical torsion elements 180 are pressed against the outer surfaces of the mounting bars 110, 120, as shown in FIG. 9.

Referring again to FIG. 6, the mounting bar 110 can be attached to the tool frame 100 by a plurality of mounting brackets 200 and at least one adjustment mounting bracket 250.

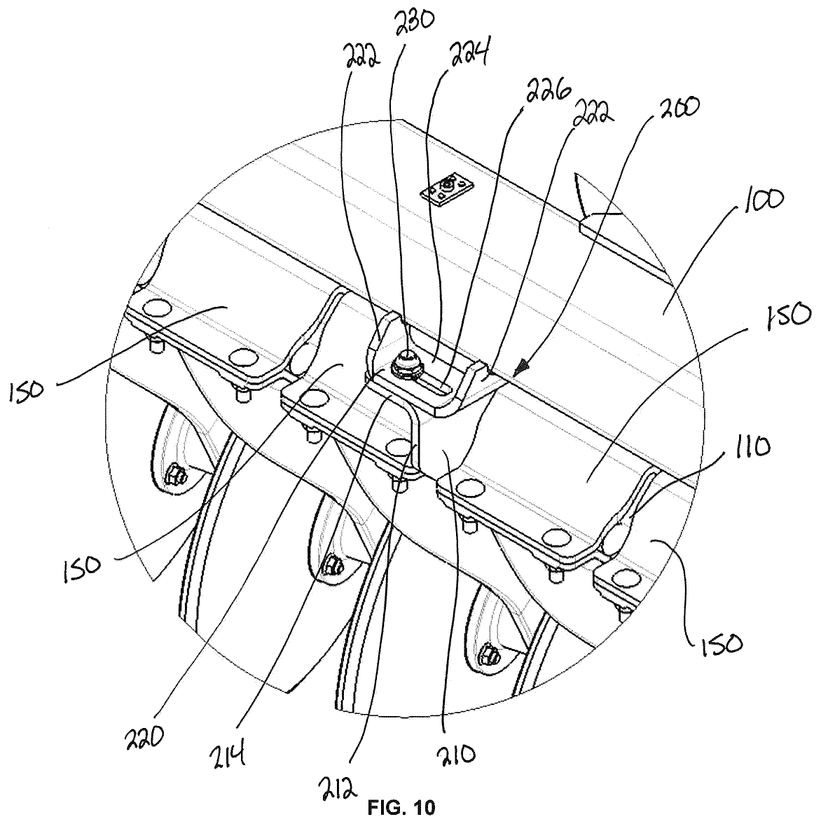

FIG. 10 illustrates one of the mounting brackets 200 for attaching the mounting bar 110. The mounting bracket 200 can include a connection arm 210 and a frame connector 220. The connection arm 210 can be connected to the mounting bar 110 and have a connection member 212 extending from the mounting bar 110 and a connection flange 214 extending, from a distal end of the connection member 210, perpendicular to the connection member 212. An aperture (not shown) can pass through the connection flange 214.

The frame connector 220 can have connector members 222 connected to the frame 100 and a connector flange 224 extending between the connection members 222. An elongate slot 226 can be provided in the connector flange 224.

The connection flange 214 of the connection arm 210 can be positioned adjacent to the connector flange 224 of the frame connector 214 so that the aperture in the connection flange 214 of the connection arm 210 can be substantially aligned with the elongate slot 226 in the connector flange 224 of the frame connector 220.

A connector 230, such as a bolt and a nut, can be provided passing through the elongate slot 226 in the connector flange 224 of the frame connector 220 and the connection flange 214 of the connection arm 210 to allow the connection arm 210 to move laterally relative to the frame connector 220 and therefore the mounting bar 110 to move laterally relative to the tool frame 100, when the connector 230 is loosened.

In a further aspect, an elongate slot can be provided in the connection flange 214 of the connection arm 210, instead of the elongate slot 226 in the connector flange 224 and an aperture can be provided in the connector flange 224, with the connector 230 passing through the aperture in the connector flange 224 and the elongate slot in the connection flange 214.

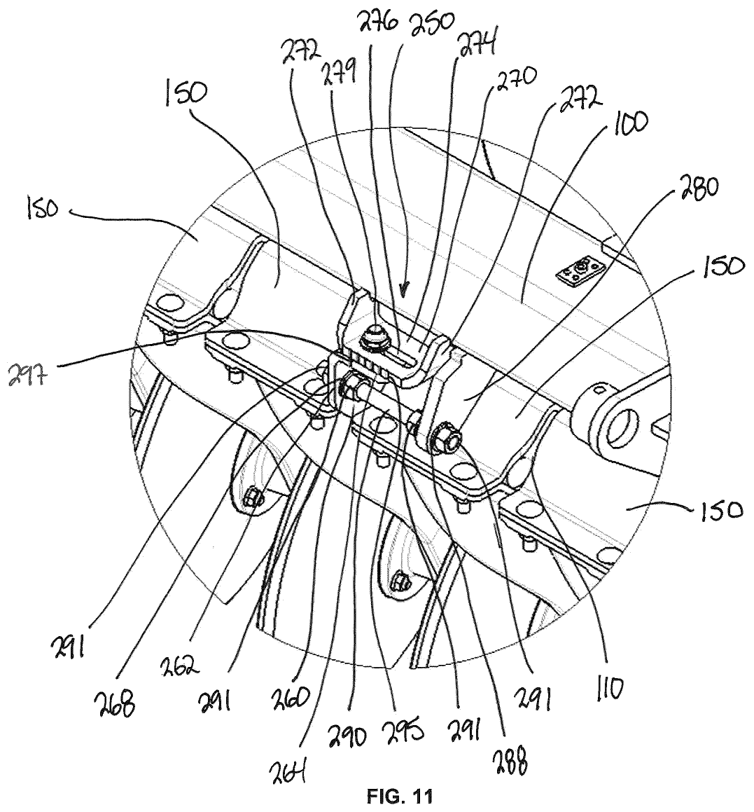

FIG. 11 illustrates the adjustment mounting bracket 250. The adjustment mounting bracket 250 can include a connection arm 260, a frame connector 270, an adjustment member 280 and an adjustment rod 290. The connection arm 260 can be connected to the mounting bar 210 and have a connection member 262 extending, at a first end, from the mounting bar 210, and a connection flange 264 extending, from a second end, of the connection member 262, perpendicular to the first end of the connection member 262. An aperture (not shown) can be provided in the connection flange 264 and an aperture 268, sized to accept the adjustment rod 290, can be provided in the connection member 262.

The frame connector 270 can have connection members 272, connected to the tool frame 100, and a connector flange 274 extending between the connection members 272. An elongate slot 276 can be provided in the connector flange 274.

The adjustment member 280 can extend downwards from the frame connector 270 and/or the tool frame 100. An aperture 288 can be provided in the adjustment member 280, sized to accept the adjustment rod 290.

The connection flange 264 of the connection arm 260 can be positioned adjacent to the connector flange 274 of the frame connector 270 so that that the aperture in the connection flange 264 of the connection arm 260 can be substantially aligned with the elongate slot 276 in the connector flange 274 of the frame connector 270.

A connector 279, such as a bolt and a nut, can be provided passing through the aperture in the connection flange 264 of the connection arm 260 and the elongate slot 276 in the connector flange 274 of the frame connector 270 to allow the connection arm 260 to move laterally relative to the frame connector 270 and therefore the mounting bar 110 to move laterally relative to the tool frame 100, when the connector 279 is loosened.

The adjustment rod 290 can be provided between the connection arm 260 and the adjustment member 280 with the adjustment rod 290 passing through the aperture 268 in the connection member 262 and the aperture 288 in the adjustment member 280. The adjustment rod 290 can be threaded so that nuts 291 can be used to on the threaded adjustment rod 290.

Optionally, markings 295 can be provided on the connector flange 274 of the frame connector 270 and an indicator marking 297 provided on the connection flange 264 of the connection arm 260 so that a user can visually determine the lateral offset distance of the ground engaging tools 150 the ground engaging tools 150 on the first mounting bar 110 have been moved.

In a further aspect, an elongate slot can be provided in the connection flange 264 of the connection arm 264, instead of the elongate slot 276 in the connector flange 274, and an aperture can be provided in the connector flange 274 with the connector 279 passing through the aperture in the connector flange 274 and the elongate slot in the connection flange 264.

Although the plurality of mounting brackets 200 and the at least one adjustment mounting bracket 250 are shown connecting the first mounting bar 110 to the tool frame 100, mounting brackets 200 and at least one mounting bracket 250 can also be used to connect the second mounting bar 120 to the tool frame 100, in addition to or instead of being used for the first mounting bar 110. This would allow the second row of ground engaging tools 150B to be adjusted laterally relative to the first row of ground engaging tools 150A. Both the first row of ground engaging tools 150A and the second row of ground engaging tools 150B can be made laterally adjustable with the mounting brackets 200 and the adjustable mounting bracket 250 or only one of the first row of ground engaging tools 150A and the second row of ground engaging tools 150B can be made laterally adjustable.

In operation, the mounting brackets 200 and the at least one adjustment mounting bracket 250 can be used to adjust the lateral offset of the first row of ground engaging tools 150A connected to the first mounting bar 110 and therefore the discs 152 of the ground engaging tools 150 in the first row of ground engaging tool 150A relative to the ground engaging tools 150 in the second row of ground engaging tools 150B connected to the second mounting bar 120 and shift the discs 152 in the first row of ground engaging tools 150A laterally relative to the travel direction, T, of the cultivator 10.

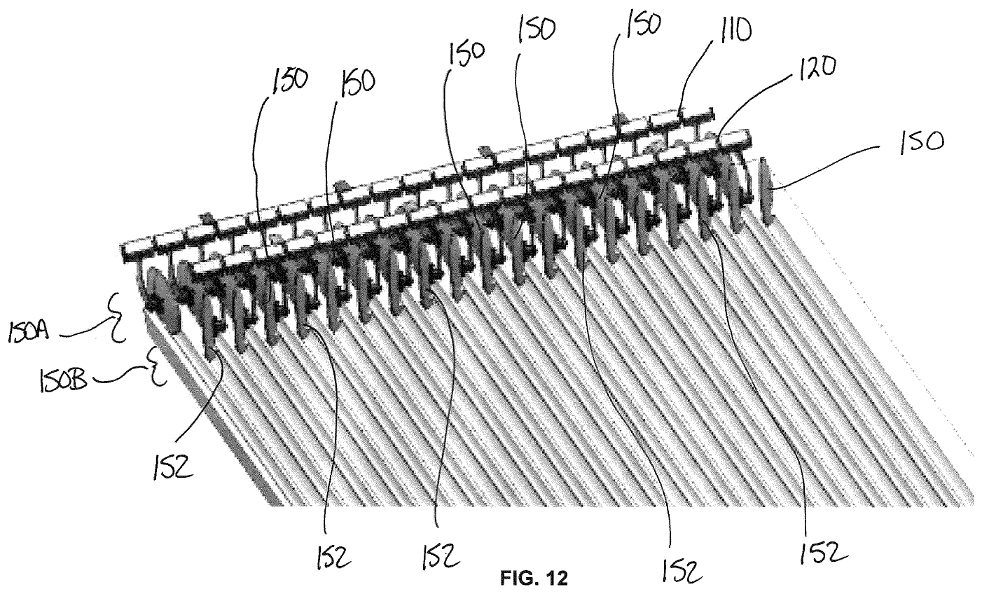

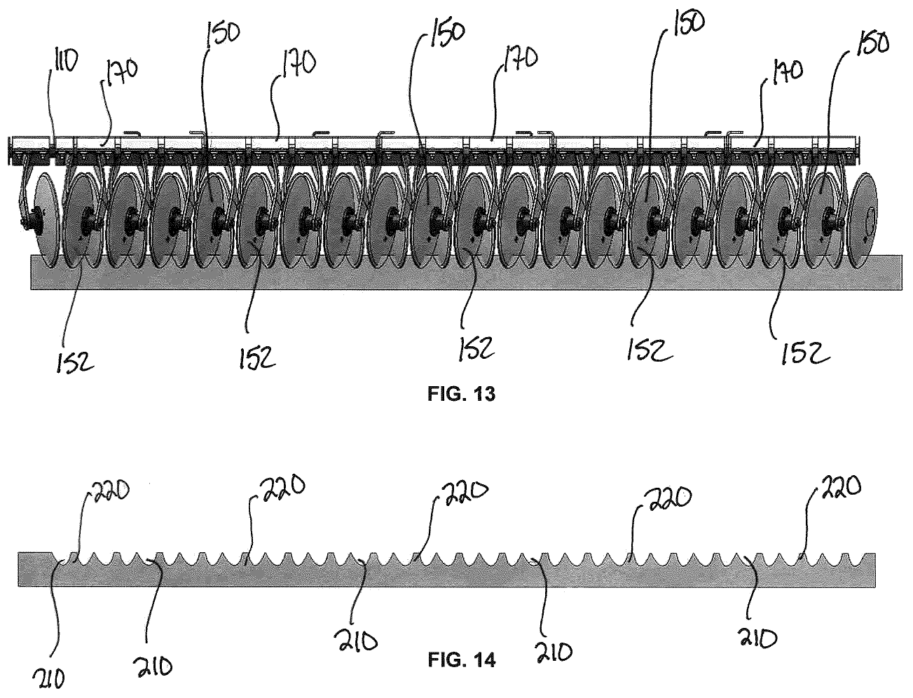

Referring to FIGS. 12 and 13, angled discs 152 on the ground engaging tools 150 agitate the soil as the tool frame 100 is pulled through a field. The first mounting bar 110 will support the first row of ground engaging tools 150A and the second mounting bar 120 will support the second row of ground engaging tools 150B. As each disc 152 is pulled through the soil, it will form a cutting profile 210 in the soil as shown in FIG. 14. The front cutting edge 153 of the disc 152 will pass through the soil and then the soil will be pushed out along the forward face 154 of the disc 152 before it is thrown off the trailing edge 155 of the disc 152.

Each cutting profiles 210 will have an approximately parabolic shape which starts at its greatest width at the surface of the soil and tapers to no cut at the deepest point of the cutting profile 210. At the ground surface, the width of the cutting profile is typically less than the spacing of the discs 152, leaving soil paths 220 of untouched soil between the cutting profiles 210.

FIGS. 12 and 14 illustrate what these cutting profiles 210 and soil paths 220 would look like if the discs 152 are pulled through the soil at a very slow speed. If the discs 152 are pulled through the soil faster, soil that passes along the forward face 154 of the disc 152 will be flung off the trailing edge 155 of the disc 152. This thrown soil can hit and fracture the soil in the soil paths 220, knocking down the soil paths 220, breaking up the untilled soil in these soil paths 220 which can have the effect of a completely tilled pass.

As the soil conditions change, such as the moisture content, compaction of the soil in the field, amount of surface residue, etc., it can change the distance soil is thrown off the trailing edges 155 of the discs 152 as the ground engaging tools 150 are pulled through the soil and therefore the effectiveness of the discs 152 and their ability to knock down the soil paths 220 between the cutting profiles 210. Additionally, over time and with repeated use to till soil, the discs 152 can wear down causing the diameter of the discs 152 to decrease and therefore the discs 152 will create narrower cutting profiles 210. These narrower cutting profiles 210 will increase the width of the soil paths 220 between them.

To address this, the first row of soil engaging tools 150A can be laterally shifted over (or the second row of soil engaging tools 150A if the mounting brackets 200 and adjustable mounting bracket 250 are provided on the second mounting bar 220) to move the discs 152 on the soil engaging tools 150 over and therefore move the cutting profiles 210 created by the discs 152 over. The connectors 230 passing through the elongate slots 226 on the mounting brackets 200 can be loosened to allow the connection arm 210 of the mounting brackets 200 to move laterally relative to the frame connector 220 of the mounting brackets 200 and the connector 279 passing through the elongate slots 276 on the adjustment mounting bracket 250 can be loosened to allow the connection arm 260 to move laterally relative to the frame connector 270.

The adjustment rod 290 can then be used to set the desired lateral offset. The nuts 291 can be adjusted on the adjustment rod 290 to set the distance between the adjustment member 280 and the connection member 262. This will therefore set the lateral offset of the connection arm 260 and the frame connector 270 of the adjustment member 280 which in turn will set the offset of the tool frame 100 and the first mounting bar 110. The first row of ground engaging tools 150A that are connected to the first mounting bar 110 will therefore be offset laterally from their previous position.

When the desired offset is achieved with the adjustment rod 290, the connector 279 on the adjustment mounting bracket 250 and the connectors 230 on the mounting brackets 200 can be tightened to secure the lateral offset of the first row of ground engaging tools 150A and the tool frame 100.

By offsetting the first row of ground engaging tools 150A, the cutting profiles 210 made by the discs 152 on the first row of ground engaging tools 150A will be offset laterally from where they were previously. This will mean the front cutting edge 153 of each disc 152 can cut further into the adjacent soil which would have formed part of an adjacent soil path 220. The speed of the cultivator 10 can also be increased, causing the soil thrown off of the trailing edge 155 of the disc 152 to be thrown further to facture the soil path 220 adjacent to the trailing edge 155 of the disc 152.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A cultivator comprising:
a hitch assembly connectable to a tow vehicle to tow the cultivator in a travel direction;
a tilling section having a front end and a back end;
a tool frame provided in the tilling section;
a mounting bar provided below the tool frame;
a plurality of ground engaging tools connected to and extending below the mounting bar;
a plurality of mounting brackets attaching the mounting bar to the tool frame, the mounting bracket allowing the mounting bar to be moved laterally relative to the tool frame; and
at least one adjustment mounting bracket attaching the mounting bar to the tool frame and operative to adjust the mounting bar laterally relative to the tool frame.

2. The cultivator of claim 1 wherein the adjustment mounting bracket is operative to adjust the mounting bar laterally.

3. The cultivator of claim 1 further comprising a first row of ground engaging tools and the second row of ground engaging tools, the first row of ground engaging tools is connected to a first mounting bar and the second row of ground engaging tools is connected to a second mounting bar, wherein the second row of ground engaging tools is positioned behind the first row of ground engaging tools.

4. The cultivator of claim 1 wherein each ground engaging tool comprises: a disc arm having a top end an a bottom end; a disc rotatably attached to the bottom end of the disc arm; and an attachment mechanism attached to a top end of the disc arm.

5. The cultivator of claim 4 wherein the disc is angled by the disc arm to be at an angle to the travel direction.

6. The cultivator of claim 1 wherein the at least one adjustment mounting bracket comprises: a connection arm connected to the mounting bar; a frame connector connected to the tool frame; an adjustment member; and an adjustment rod provided between the adjustment member and the connection arm to adjust the connection arm relative to the frame connector.

7. The cultivator of claim 6 wherein the adjustment rod is threaded and nuts are used to adjust the connection arm relative to the frame connector.

8. The cultivator of claim 6 wherein the connection arm comprises: a connection member extending at a first end from the mounting bar; and, a connection flange extending from a second end of the connection member, perpendicular to the connection member.

9. The cultivator of claim 6 wherein the frame connector comprises: connection members connected to the tool frame; and, a connector flange extending between the connection members.

10. The cultivator of claim 8 further comprising: a first aperture provided in the connection flange; and a second aperture provided in the adjustment member, the first aperture and the second aperture sized to accept the adjustment rod.

11. The cultivator of claim 6 wherein the adjustment member extends from one of: the frame connector; and, the tool frame.

12. The cultivator of claim 9 further comprising an elongate slot provided in the connector flange.

13. The cultivator of claim 12 further comprising a connector passing through the elongate slot to the connection arm, to allow the connection arm to move laterally relative to the connection flange when the connector is loosened.

14. The cultivator of claim 9 further comprising at least one marking on the connection flange and at least one marking on the connection arm to visually indicate a lateral offset distance.

15. The cultivator of claim 1 wherein the mounting bracket comprises: a connection arm connected to the mounting bar; a frame connector connected to the tool frame; a elongate slot; and a connector connecting the connection arm and the frame connector through the elongate slot.

16. The cultivator of claim 15 wherein loosening the connector allows the connection arm to move relative to the frame connector, and wherein tightening the connector prevents the connection arm moving relative to the frame connector.

17. The cultivator of claim 15 wherein the connection arm of the mounting bracket comprises: a member extending from the mounting bar; and, a connection flange extending between the connection members.

18. The cultivator of claim 17 wherein the elongate slot is provided in the connection flange.
